(19) United States
(12) Patent Application Publication
(10) Pub. No.: US 2009/0198954 A1
(43) Pub. Date: Aug. 6, 2009

(54) Method and system for generating location codes

(75) Inventor: Stephen R. Sanders, Celina, TX (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 12/012,391

(22) Filed: Feb. 1, 2008

(51) Int. Cl. G06F 12/02

(52) U.S. Cl. 711/212; 711/E12.005

(57) ABSTRACT

The present disclosure provides a method for generating a standardized location code is provided that comprises extracting an address component from an input location data record, parsing the address component into one or more address words, and processing the address words by validating the address words one by one using one or more validation rules specific to the input location data record. The method also includes constructing the standardized location code by assembling the processed address words and producing an updated location data file to be shared with a plurality of subscribing applications.

### BACKGROUND OF THE DISCLOSURE

A business often needs to share its facility location data with one or more other businesses. For example, in a supply chain, a supplier has a need to let its downstream clients know a change to an existing facility location, an addition of a new facility, or temporary or permanent unavailability of a facility. A change to the facility location data records need to be communicated in a timely fashion to all the client applications that subscribe to updates to a particular facility location data record.

A facility location data record may contain a variety of fields. For example, common fields found in location data records may include an identifier field, a name field, an address field, a location type field, and associated client information, among others. An application of one enterprise may have facility location data records in a proprietary format that is different from formats of location data records of other enterprises.

### SUMMARY OF THE DISCLOSURE

According to one embodiment of the present disclosure, a method for generating a standardized location code is provided that comprises extracting an address component from an input location data record, parsing the address component into one or more address words, and processing the address words by validating the address words one by one using one or more validation rules specific to the input location data record. The method also includes constructing the standardized location code by assembling the processed address words and producing an updated location data file to be shared with a plurality of subscribing applications.

According to another embodiment of the present disclosure, a system is provided for generating a standardized location code. The system includes a memory operable to store a plurality of location code abbreviations, standardized location codes, and location data records. The system also includes one or more processors collectively operable to extract an address component from an input location data record, to parse the address component into one or more address words, and to process the one or more address words by validating the address words one by one using one or more validation rules specific to the input location data record. The one or more processors are collectively operable to construct the standardized location code by assembling the processed address words and to produce an updated location data file to be shared with a plurality of subscribing applications.

According to yet another embodiment of the present disclosure, a computer program embodied on a computer readable medium and operable to be executed by a processor is provided. The computer program comprises computer readable program code for extracting an address component from an input location data record, for parsing the address component into one or more address words, and for processing the one or more address words by validating the address words one by one using one or more validation rules specific to the input location data record. The computer program also includes computer readable program code for constructing the standardized location code by assembling the processed address words and for producing an updated location data file to be shared with a plurality of subscribing applications.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. The terms “firewall log record manager” and “firewall log record management system” refer to a software system, hardware system, or system that combines hardware and software components that can perform management related functions on a large number of firewall log records. The two terms and their equivalents may be used interchangeably throughout the disclosure. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in accordance with a disclosed embodiment;

FIG. 2 depicts a block diagram of a networked location data hub (LDH) coupled with applications via a communication networks accordance with a disclosed embodiment;

FIG. 3 depicts a block diagram of a location data hub system including a standardized location code generator;

FIG. 4 depicts a block diagram of a location code generator in accordance with a disclosed embodiment;

FIG. 5 depicts a method for generating standardized location code; and

FIG. 6A and FIG. 6B illustrates a flow diagram for an exemplary operations of a location code generator.

### DETAILED DESCRIPTION

Some enterprise applications maintain facility location data independently in multiple applications. Each system uses its own proprietary coding system for identifying facility locations. This makes it difficult for an enterprise application to share its location data with applications of other enterprises to meet business needs. In addition, either there are few mechanisms for validating location data across applications or there is no validation at all.

Traditionally, there have been two approaches to exchanging the facility location data between client applications. The first approach is to directly export the entire data base from an upstream client database to a downstream client applicant database. This approach requires many point-to-point interfaces to allow all client applications that have a need to share the facility location data to do so. In addition, this approach requires that both the upstream and downstream applications to use the same database, the same application code or the same application program interfaces (API) at a minimum. These requirements may not be practical. The second approach is to build cross-references manually between the keys of two application databases that need to share the location record data. This approach is time consuming and error prone. Therefore, there is a need for a centralized application that can validate the location data input from an enterprise application, and convert the proprietary data format into a standardized format. One central step in converting the proprietary data format into a standardized format is a systematic way and system for generating a standardized location code for an input address component.

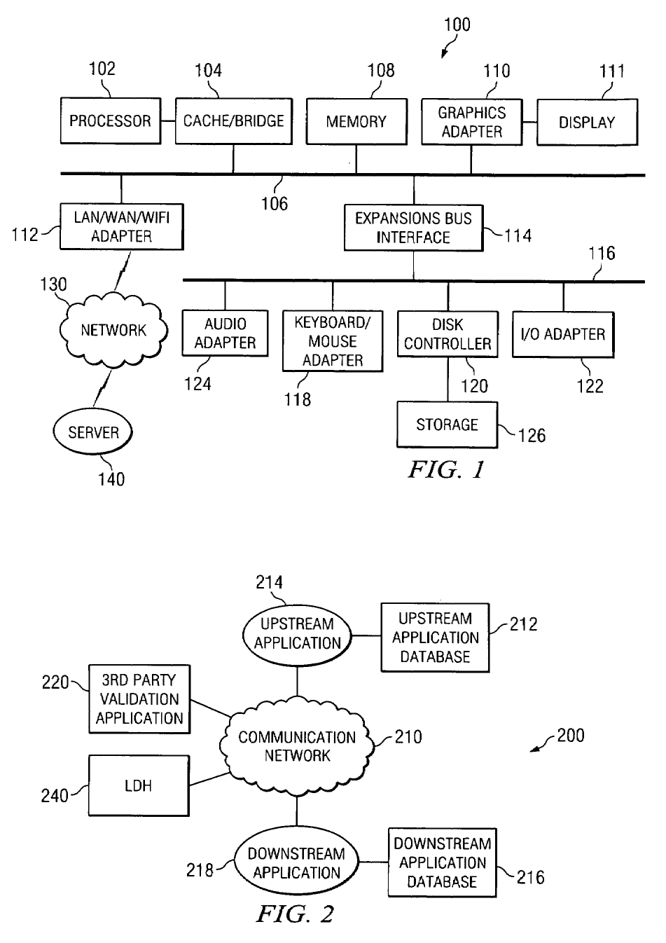

FIG. 1 through FIG. 6, discussed below, and the various embodiments used to describe the principles of the present disclosure in this patent document are by way of illustration only and should not be construed in any way to limit the scope of the disclosure. Those skilled in the art will understand that the principles of the present disclosure can be implemented in any suitably arranged device. The numerous innovative teachings of the present application will be described with reference to exemplary non-limiting embodiments.

FIG. 1 depicts a block diagram of a data processing system in which an embodiment of the present disclosure can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, a trackball, and a trackpointer, etc.

Those of ordinary skill in the art will appreciate that the hardware depicted in FIG. 1 may vary for particular embodiments. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

FIG. 2 depicts a block diagram of a networked location data hub (LDH) 200 coupled with applications via a communication networks 210 in accordance with a disclosed embodiment. The networked location data hub 200 includes the communication network 210, a location data hub 300, a 3^{rd} party validation application 220, an upstream client application 214 and an associated upstream application database 212, and a downstream application 218 and an associated downstream application database 216. Most of the components of the network location data hub 200, such as the location data hub 300, the 3^{rd} party validation application 220, the upstream client application 214, and the downstream application 218, can be implemented on the data processing system 100 as shown in FIG. 1.

The communication network 210 can be a combination of a public Internet and a private network that belongs to an enterprise and that is interconnected to the public Internet. One example of such an interconnected network scenario is a supply chain network. The communication network 210 can contain, for example, a supplier's enterprise network and one or more public IP networks so the downstream clients of the supplier chain can access their accounts on the supplier's network via the public Internet. The supplier network can also be interconnected to a network belonging to a partner such as a financial transaction partner that can deliver financial transaction service to the supplier's customers. Various applications belonging to different businesses can be connected to each other via the communication network 210.

The upstream application 214 and the associated application database 212 are providers of the facility location data records. For example, an auto parts manufacturer can have an application for managing data of various auto part facility locations to provide auto parts to its clients. The upstream application database 212 can be a location database for facility locations where auto parts may be retrieved or delivered.

The downstream application 218 and the associated downstream application database 216 are the consumers of the facility location data provided by the upstream application 214. For example, the downstream application 218 can be an application of an auto part retail chain that needs to have up-to-date information on parts supplier's facility location. The downstream client application database 216 can be a database that the auto parts retailer maintains on the auto parts of various suppliers.

In the example above, the upstream application 214, i.e., the auto part supplier's application, may have updates to its facility location from time to time. In addition, the information of which facility location has what parts also change frequently. These updates on facility location data need to be communicated to the downstream applications 212 in a timely manner.

A conventional approach to exchanging the facility location data between the upstream application 214 and the downstream application 218 is to directly export the entire data base from the upstream database 212 to the downstream applicant database 216. This approach requires many point-to-point interfaces to allow all client applications that have ad need to share the facility location data to do so. In addition, this approach requires that both the upstream and downstream applications to use the same database, the same application code or application program interfaces (API) at a minimum. These requirements may not be practical.

The location data hub 300 is introduced to facilitate the facility location data sharing between the upstream application 214 and the downstream application 218. The location data hub 300 provides a common API for the applications to connect to a common database. The location data hub 300 can validate the syntax and semantics of a client location facility data record, using validation rules and a third party validation application 220. The location data hub 300 can standardize the client facility location data record and generate a standardized facility location data record. The standardized facility location data can serve as a reference point for various client location data records of different format associated with different applications. In addition, the location data hub 300 can provide a cross-reference between proprietary client location facility data records. The location data hub 300 can also publish the updated, standardized facility location data to all subscribing applications.

The 3^{rd} party validation application 220 and a validation database may provide validation function and data needed to validate the location data record. The 3^{rd} party validation application 220 may have its own data base or an independent database (not shown). The location data hub 300 may use the 3^{rd} party validation application 220 and the associated database to validate the client facility data. A common 3^{rd} party location data is Postal Office database that can be used to validate whether an address in the client facility location data record is valid.

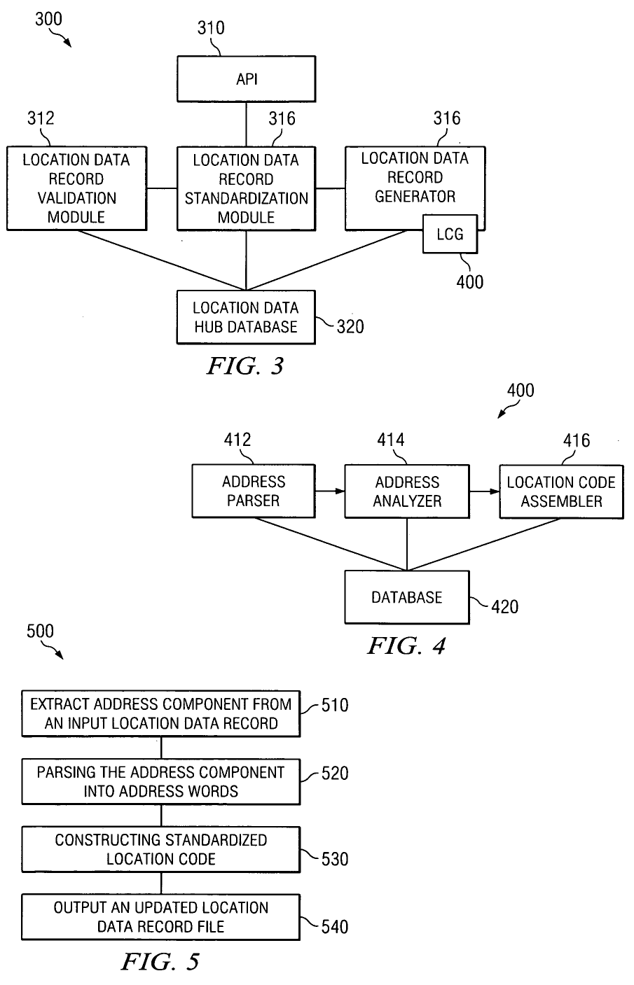

FIG. 3 depicts a block diagram for functional modules of a location data hub 300 in accordance with a disclosed embodiment. The location data hub 300 include a location data validation module 312, an API 310, a location data standardization module 416, a location data address generator 316, and location data hub database 320. The location data hub can be implemented on the data processing system 100, as shown in FIG. 1.

FIG. 3 depicts a block diagram of a location data hub 300 including various modules in accordance with a disclosed embodiment. In one embodiment, the location data hub 300 includes a location data record validation module 312, an API 310, a location data record standardization module 316, a location data record generator 316, and a location data hub database 320. The location data record generator 316 in turn includes a location code generator 400.

Location data records are stored in the location data hub database 320, shared with the client applications via the API 310 and are validated at the location data validation module 312. In one embodiment, the location data record can include a name field, a location type field, an address component field, an identifier field, and a related client info field. The name field may be client name, a business address or special name. The location type field may have a ship_to type, a ship_from type, or a bill_to type, among others.

The address component field may include a number of parts such as a country part, a state or province part, a city part, and a street part. Optionally, the address component field may also include a delivery point part. An example of the delivery point part is a building number on a street address which may have multiple buildings sharing the same street address. Some parts of the address component can be validated and some parts of the address component can not be validated. The regular address may include a country code, a state or province name, a city name, a county name and/or a town name. The location data record may include a mandatory portion and optional portion. For example, the city name or code can be mandatory portion of an address while the county name can be an optional part. The mandatory part may be validated and the optional parts may not be validated.

The API module 310 can provide a program interface to external applications such as upstream applications 314 and downstream client application 318 and 322. The API, in one embodiment, is a standard XML interface. The standard API can simplify the communication between the location data hub 300 and other applications such as the downstream application 318 and 322 and the upstream applications 310, 312, and 314. The API can also provide a queue to hold location data record updates to for the downstream client applications to retrieve.

The location data validation module 312 can validate an input location data record. The validation can include checking whether the address is valid and whether the location data is complete. Some parts of a location data record is mandatory and some are optional. For example, a city part of an address component is mandatory while county part of the address may be optional. A street address may be mandatory while delivery points of a street address may be optional. The mandatory portions of the location data records are checked. The validation can often be performed using a third party validation application. One example of validation application is US. Postal address validation that can check whether an input address exists. The location data validation module 312 can also send a notification to an outside client application on a location data record that has failed the validation.

The location data standardization module 316 may add missing part and convert the non-standard component into a standard component. Some parts of location data record may be mandatory for some applications or some clients but optional for some other clients or applications. For example, the county portion in an address may be optional in some cases and mandatory in some other cases. The standardization module may fill in the missing part if it is mandatory but missing from the location data record. For example, a 3^{rd} party application may provide a corresponding county name if a city name is provided.

The location data standardization module 316 may standardize the input location data record. For example, the state or province part or a city part of the address component is provided but is not standardized. For example, the standardization module 316 can standardize an input location data record by converting a variable-length part into a fixed length part. For example, in one embodiment, a country name of variable length can be converted to a fixed-length country code.

The location data record generator 316 may generate standardized part of address. The standardized part of address may include a city code and a county code. The location data record generator 316 may assemble standardized components into a standardized location data record and store the record into a database. One part of the location data record generator 316 is the location code generator (LCG) 400. The location code generator 400 can generate a standardized location code of from a non-standardized location name. For example, the location code generator 400 can convert a city name of any length into a standardized city code of a fixed length. More details of the location code generator 400 is depicted in FIG. 4 and described therein.

The location data hub database 320 can be a local database. In another embodiment, it can be an external database FIG. 3 shows an internal database 320. The database 320, according to some embodiments of the current disclosure, can be implemented on a combination of the memory 108 and the data storage 126 of the data processing system as shown in FIG. 1. The location data hub database 320 can be configured to store and manage the facility location data records, data security rules, and address abbreviation records. The database 320 can be implemented using a rational database, an object-oriented database, or a future database technology. The database 320 may be centrally located or distributed across multiple geographical areas, depending on the system design.

FIG. 4 depicts a block diagram of a location code generator 400 in accordance with a disclosed embodiment. The location code generator 400 includes an address parser 412, an address analyzer 414, a location code assembler 416, and a database 420. The database 420 can be an independent database or part of the location data hub database 320. The location code generator 400 can be implemented on the data processing system 100, as shown in FIG. 1.

The address parser 412 can parses an input address component into one or more address words. For example, an input city name may have multiple words. The address parser 412 parses the city name into multiple address words for subsequent analysis and processing. The address parser 412 can detect syntax errors in the input address name. For example, the first character of the city name that is something other than an alphabetic character is a syntax error.

The address analyzer 414 can check whether an input address word generated from the address parser 412 is valid. The analyzer 414 can check with a third party address validation database and a third party address validation application to determine whether an input address is valid or not. The address analyzer 414 can also check whether a combination of country, city and sub-region is unique.

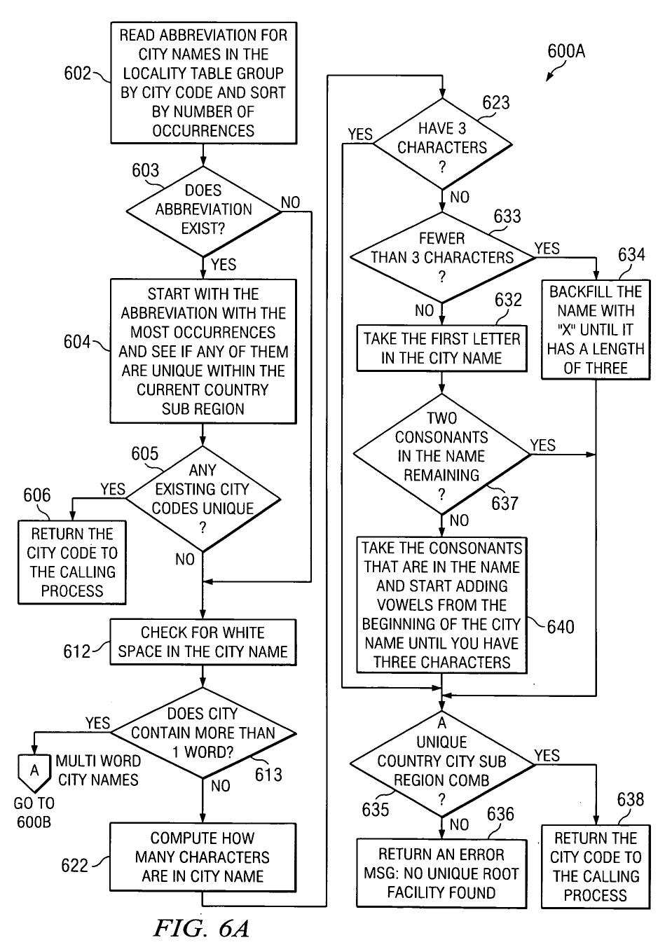

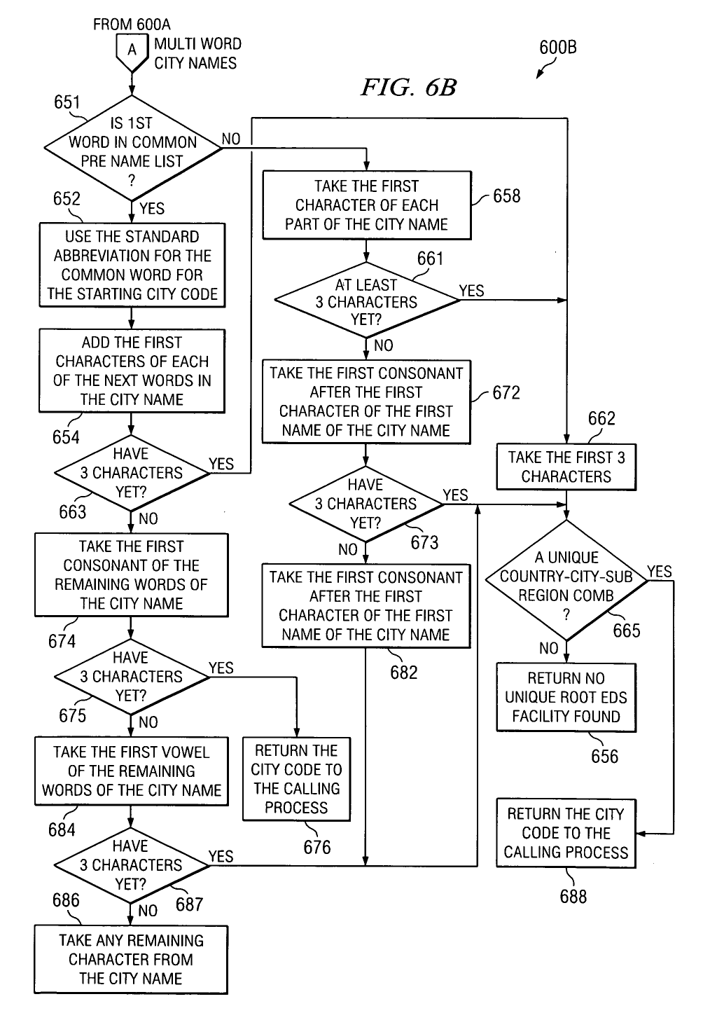

The location code assembler 416 can follow an algorithm and generate a location code such as a city code, using the output from the address parser 412 and the address analyzer 414. For example, in one embodiment, as shown in FIG. 6A and FIG. 6B, an exemplary algorithm for generating a city code is presented. The exemplary algorithm allows the location code assembler to follow two operation paths, one path for the case where the address component is made of a single address word, and other path is for the case where the address component is made of multiple address words. FIG. 6A and FIG. 6B present details of this exemplary algorithm.

FIG. 5 depicts a method 500 for generating standardized location code. The method 500 may include a step of extracting address component from an input location data record at 510, a step of parsing the address component at 520, a step of constructing a standardized location code at 540, and a step of producing an updated location data record file at 550.

The step of extracting address component at 512 can include receiving data from an input source and extracting the needed part of the location data record. The location data record can be received via a manual input source, a client program interface or a data import API. Extracting the address component from the received location data record can involve breaking the location data record into an address component, a location type field, an identifier part, and an associated client information part, and taking out the address component for further processing.

The step of parsing the address component at 520 can include breaking the address component into multiple address words. For example, an address component may include a country, a state or province, a sub-region, a street name, and an optional delivery point. Each part of the address component may include one or more words. According to one embodiment, the address parser breaks each part into one or more address words and organizes the address words into a hierarchical tree.

The step of constructing a standardized location code at 530 can include analyzing the parsed address words and assembling the location code from the parsed address words. Analyzing the address words can involve determining the number of address words contained in the input address component, a length of each address word, type of character such as consonant or vowels in the address word, and presence or absence of an abbreviation. Analyzing the address words also involves checking whether or not an abbreviation in an address word is a standard one, and whether a generated location code is unique when combined with other parts of the address component.

Assembling the location code from parsed address words can involve extracting input to the location code, checking various constraints, and building a location code. Extracting the input involve deciding whether an address word or part of it can become part of the location code according to a predefined algorithm. For example, in one embodiment, the rule for assembling a standardized city code is to take an input abbreviation if the length of the abbreviation is within a predetermined limit and a resulting combination of the city code, country and sub-region is unique. Checking various constrains involve checking the length of the input address word, and the uniqueness of an abbreviation or resulting location code. Building the location code can involve assembling the extracted inputs into a location code.

The step of producing an updated location data record file at 540 can include updating the location data record with the newly build location code, storing the updated location data record in the database, and sharing the updated location data record with one or more subscribing applications. Updating the location data record can involve updating an existing standardized location data record or creating a new standardized location data record with the location code generated through the preceding steps. Storing the updated location data record can involve storing the updated location data record in an external or internal database. Sharing the updated location data record can involve sending the updated location data record to one or more subscribing application or placing the updated location data record at a known location such as a message queue for the subscribing applications to retrieve.

FIG. 6A and FIG. 6B illustrates a flow diagram for an exemplary operations 600A and 600B of a location code generator. This exemplary location code generator is configured to generate a city code of a fixed length from a city name of variable length. The location code generator can be configured to generate location code for other types of location such as a street or a region. In this exemplary embodiment, the length of city code is set to 3 characters. The location code generator such as this city code generator is a part of a location data hub that is configured to translate a proprietary location data record into a standardized location data record. The standardized city code is part of the standardized location data record. The flow diagram is divided into a part 600A and a portion 600B. When multiple unique facility locations are defined at the city level, a sequence number is used to differentiate the facility location

The input to the location code generator 400 is an address component that include a country, a state or province, a sub-region in the state, and a city name. The output from the location code generator is a standardized city code of a fixed length. The part 600A is for the operations of the location code generator that handles the case where the input city name has a single word. The portion 600B depicts the operation of the location code generator when the city name has multiple words.

The first part of the operation, the portion 600A, starts with reading into the city code generator 400 an abbreviation list for city names at 602. The abbreviations are sorted by the number of occurrences for a city name and the city names are alphabetically sorted. Then a search is performed for the input city name at the block 603. If the input city name is found in the abbreviation list, the location code generator continues to find the most occurrences of the input city name at the block 604. A city may have multiple abbreviations in the location database. Then the abbreviation with a highest number of occurrences is selected. Then a query is performed at the block 605 to see if this abbreviation with the most occurrences is unique for the city within the sub region to which the city belongs. If the abbreviation is unique, then the location code generator stops at the block 606 and output the unique abbreviation as the standardized city code at the block 606.

If there is no abbreviation found for the input city name or the abbreviation is not unique, then the location code generator proceeds to the block 612 to check whether the city name contains more than one word. If the city name has multiple words, the location code generator proceeds to the 600B part. Otherwise, the location code generator proceeds to the block 622 to determine the number of characters contained in the single-worded city name at the block 623. If the city name has three characters, the location code generator proceeds to the block 635 to determine whether a combination of the state, sub-region, and the city name is a unique at the block 635. If it is a unique combination, the location code generator returns the city code just found at the block 638. If the combination is not unique, the location code generator proceeds to generate an error message for failing to generate a city code at the block 636.

If the input city name has fewer than 3 characters, the location code generator backfill the city code with the character “X” at the block 634. If the input city name has more than 3 characters, the location code generator takes the first character of the input city name as the first character of the output city code at the block 632. Then the location code generator checks whether there are two consonants remaining in the input city name at the block 637. If less than 2 consonants remain in the input city name, the location code generator takes the consonant as the next character of the city code and adding vowels from the beginning of the input city name until the predetermined length of the city code (3 characters) is reached at the block 640. If there are two consonants remaining in the city name, then take the consonants as the output city code and proceed to the block 635 to make sure that the resulting combination of the city code, the country and the sub-region is unique as before.

The portion 600B shows the operations of the location code generator for generating the city code when the input city name has multiple words. The location code generator first checks whether the first word is in a standard abbreviation list at the block 658. If yes, the location code generator uses the standard abbreviation as the first character of the output city code at the block 652. Then the location code generator adds the first character of each of the remaining words in the input city name at the block 654 and then determines whether the predetermined length is reached at the block 663. If it is determined that the length is reached at the bock 663, then the location code generator proceeds to check whether the combination of the city code, country, and sub-region is unique at the block 665. If the combination is not unique, then the location code generator return an error message for failing to generate a city code at the block 656. If yes, the location code generator outputs the city code at the block 662. If the predefined length is not reached, the location code generator takes the first consonant of the second word after the first character of the input city name at the block 674. Then, if the predetermined length of the city code is reached, the location code generator proceeds to output the city code at the block 676. If the predefined length is not reached, then the location code generator takes the first vowel of the remaining words of the input city name at the block 684. If it is determined at the block 687 that the predetermined length is reached, as before, proceeds to check whether the resulting combination is unique at the block 665. If the predefined length is not reached, the location code generator takes any remaining characters from the input city name at the block 686.

If the first word of the input city name is not found in the standard abbreviation list at the block 651, the location code generator takes the first character of each word of the input city name at the block 658. If it is determined at the block 661 that the resulting city code has at least as many characters as the predetermined length, then location code generator takes first three characters at the block 662 and then checks whether the resulting combination is unique at the block 665 as before.

If it is determined at the block 661 that resulting city code has less than the predetermined length, then the location code generator takes the first consonant after the first character of the first name of the input city name at the block 672. Then if the resulting city code reaches the predetermined length at the block 673, the location code generator proceeds to the block 665 to check whether the resulting combination is unique, as before. If it is determined at the block 673 that the predefined length is not reached, then the location code generator takes the first consonant after the first character of the first name of the city name at the block 682 and proceeds to the block 665 to check whether the resulting combination is unique, as before.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

This document shares some common subject matter with, but is otherwise unrelated to, U.S. patent application Ser. No. ______ (Attorney Docket Number 82-07-28), filed concurrently herewith, which is hereby incorporated by reference in its entirety.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for generating a standardized location code, comprising:
extracting an address component from an input location data record;
parsing the address component into one or more address words;
processing the address words by validating the address words one by one using one or more validation rules specific to the input location data record;
constructing the standardized location code by assembling the processed address words and sequence number; and
producing an updated location data file to be shared with a plurality of subscribing applications.

2. The method of claim 1, further comprising receiving a client location data update including the input location data record from one of a location data import application, a manual input facility, and a client application.

3. The method of claim 1, wherein parsing the address component further comprises identifying one or more abbreviations, consonants and vowels in the address words.

4. The method of claim 1, wherein validating the address component comprises checking the validity of the address component using a third party validation application.

5. The method of claim 1, wherein constructing the standardized location code comprises replacing an abbreviation in an address word with a standardized abbreviation.

6. The method of claim 1, wherein the standardized location code has a fixed location code length by country.

7. The method of claim 6, wherein constructing the standardized location code comprises checking a number of characters in the address component and if the number of the characters is equal to the location code length, taking the address component as the standardized location code.

8. The method of claim 6, wherein constructing the standardized location code comprises taking a first character of the address component as a first character of the standardized location code.

9. The method of claim 6, wherein constructing the standardized location code comprises taking the first consonant of each address word until the fixed location code length is reached.

10. The method of claim 6, wherein constructing the standardized location code comprises taking a vowel from the address component if no consonant in the address component is available and the location code length is not reached.

11. The method of claim 1, wherein constructing the standardized location code comprises backfilling the standardized address code with one or more character “x” until the location code length is reached.

12. A system for generating a standardized location code, comprising:
a memory operable to store a plurality of location code abbreviations, standardized location codes, and location data records; and
one or more processors collectively operable to:
extract an address component from an input location data record;
parse the address component into one or more address words;
process the one or more address words by validating the address words one by one using one or more validation rules specific to the input location data record;
construct the standardized location code by assembling the processed address words; and
produce an updated location data file to be shared with a plurality of subscribing applications

13. The system of claim 12, wherein the standardized location code has a fixed location code length by country.

14. The system of claim 12, wherein each of the address words has a variable length.

15. The system of claim 12, wherein the system is coupled to a location data hub from which the input location data record is received.

16. The system of claim 12, wherein the address words are separated from each other by one of separators that include a white space, a comma, and a designated character.

17. The system of claim 12, wherein the standardized location code includes one or more standardized abbreviations.

18. The system of claim 12, wherein the input location data record includes an address component field, a location type field, and an associated client information field.

19. A computer program product encoded on a computer readable medium and operable to be executed by a processor, the computer program product comprising computer readable program code for:
extracting an address component from an input location data record;
parsing the address component into one or more address words;
processing the one or more address words by validating the address words one by one using one or more validation rules specific to the input location data record;
constructing the standardized location code by assembling the processed address words; and
producing an updated location data file to be shared with a plurality of subscribing applications.

20. The computer program of claim 19, wherein the computer program further comprise computer readable program code for
a database configured with a plurality of standard abbreviations;
an address component parser configured to parse the address component into plurality of address words;
an address component analyzer configured to validate the address component using a third party address database and an address validation application; and
a standardized location code assembler configured to construct a standardized location code from the address words.
